(19) United States
(12) Patent Application Publication
(10) Pub. No.: US 2026/0267806 A1
(43) Pub. Date: Sep. 10, 2026

(54) ELECTRONIC DEVICE INCLUDING DEVICE-DEDICATED AND HOST MEMORY REGIONS

(71) Applicant: XCENA Inc., Seongnam-si (KR)

(72) Inventors: Ju Hyun KIM, Seongnam-si (KR); Dohun KIM, Seongnam-si (KR); Jae Wan YEON, Seongnam-si (KR); Kee Bum SHIN, Seongnam-si (KR)

(21) Appl. No.: 19/560,688

(22) Filed: Mar. 9, 2026

(30) Foreign Application Priority Data
Mar. 10, 2025 (KR) 10-2025-0030475

(51) Int. Cl. G06F 12/1045; G06F 9/30; G06F 12/0831

(52) U.S. Cl. CPC G06F 12/1063; G06F 9/30043; G06F 12/0831

(57) ABSTRACT

An electronic device includes a memory including a first region and a second region associated with a host memory, and a controller configured to be connected to the memory, wherein the controller is configured to access the first region based on a physical addressing scheme, and access the second region based on a virtual addressing scheme.

### CROSS-REFERENCE TO RELATED APPLICATION

This application claims priority to Korean Patent Application No. 10-2025-0030475, filed in the Korean Intellectual Property Office on March 10, 2025, the entire contents of which are hereby incorporated by reference.

### BACKGROUND

### Field

Aspects of the present disclosure relate to an electronic device and a computing system including the electronic device.

### DESCRIPTION OF RELATED ART

As technologies based on artificial intelligence, big data, and block chain develop, an accelerator, which is hardware designed to assist an operation of a central processing unit (CPU) or rapidly process a specific task, is widely used.

Because a peripheral component interconnect express (PCIe)-based accelerator uses an independent memory, a copy overhead occurs when moving data between a host device and the PCIe-based accelerator. The copy overhead causes a performance degradation, and causes a bottleneck in workloads such as deep learning and big data analysis.

To overcome such limitations, an accelerator including a compute express link (CXL) memory has emerged. The accelerator may include both a device private memory (DPM) and a CXL host attached device memory (HDM), so that a copy overhead may be prevented when moving data between the host device and the accelerator. However, an additional process as follows is necessary.

First, even though the HDM is disposed in the accelerator, the HDM is in a control range of the host device, and thus a permission of the host device is necessary whenever the accelerator uses the HDM.

Second, because the host device uses a memory address allocation scheme based on a virtual address, when the accelerator accesses the host memory (HDM), it must do so using the virtual addressing scheme. This approach allows for efficient use in scenarios where a contiguous address space in the virtual address is physically discontinuous, or when using pointer-based data structures (e.g., linked lists, trees, etc.).

The above-described information disclosed in a technology which becomes a background of an invention is merely to improve an understanding of a background of embodiments, and therefore may include information that does not constitute a related art.

### SUMMARY

To solve the above-described problems, the present disclosure provides an electronic device and a computing system using a memory of the electronic device by dividing the memory of the electronic device into a device-dedicated memory region and a host memory region.

The present disclosure may be implemented in various ways including a method, an apparatus (a system), or a computer program stored in a readable storage medium.

In some embodiments, an electronic device may include a memory may include a first region and a second region associated with a host memory, and a controller configured to be connected to the memory, wherein the controller is configured to access the first region based on a physical addressing scheme, and access the second region based on a virtual addressing scheme.

In some embodiments, the first region is a device-dedicated memory region of the electronic device, and may include data associated with at least one of a code, a stack, or a heap during a runtime of a specific program.

In some embodiments, the second region is a host memory region, and may include data satisfying cache coherence with the host memory.

In some embodiments, the controller is configured to determine whether to access the first region based on the physical addressing scheme or whether to access the second region based on the virtual addressing scheme, based on a value of a specific address bit received from a host processor.

In some embodiments, the controller may include a memory management (MM) unit and a snoop unit, the MM unit translates a virtual address space allocated to the host memory into a physical address space, the snoop unit satisfies a cache coherence between the physical address space and the second region, and the controller is configured to access the second region when the value of the specific address bit received from the host processor is a first value.

In some embodiments, the controller is configured to access the first region when the value of the specific address bit received from the host processor is a second value.

In some embodiments, a computing system may include a host device may include a host processor and a host memory, and an electronic device, wherein the electronic device may include a memory may include a first region and a second region associated with the host memory, and a controller configured to be connected to the memory and the host processor, and the controller is configured to access the first region based on a physical addressing scheme, and access the second region based on a virtual addressing scheme.

In some embodiments, the first region is a device-dedicated memory region of the electronic device, and may include data associated with at least one of a code, a stack, or a heap during a runtime of a specific program.

In some embodiments, the second region is a host memory region, and may include data satisfying cache coherence with the host memory.

In some embodiments, the controller is configured to determine whether to access the first region based on the physical addressing scheme or whether to access the second region based on the virtual addressing scheme, based on a value of a specific address bit received from the host processor.

In some embodiments, the controller may include a memory management (MM) unit and a snoop unit, the MM unit translates a virtual address space allocated to the host memory into a physical address space, the snoop unit satisfies a cache coherence between the physical address space and the second region, and the controller is configured to access the second region when the value of the specific address bit received from the host processor is a first value.

In some embodiments, the controller is configured to access the first region when the value of the specific address bit received from the host processor is a second value.

In some embodiments, a runtime executed in the host processor and the controller is configured to allocate a region associated with at least one of the code, the stack, or the heap during the runtime of the specific program.

According to various embodiments of the present disclosure, because an electronic device using a memory of the electronic device by dividing the memory of the electronic device into a device-dedicated memory region and a host memory region is provided, a memory management may be effectively performed, and a processing speed may be improved.

Effects of the present disclosure are not limited to the effects mentioned above, and other effects not mentioned will be clearly understood by a person having ordinary knowledge in a technical field to which the present disclosure belongs (hereinafter referred to as a "person having ordinary skill in the art") from descriptions of claims.

### BRIEF DESCRIPTION OF THE DRAWINGS

FIG. 1 schematically illustrates a computing system according to an embodiment of the present disclosure.

FIG. 2 illustrates a communication scheme of a computing system according to an embodiment of the present disclosure.

FIG. 3 illustrates a configuration of a controller according to an embodiment of the present disclosure.

FIG. 4 illustrates a method of accessing a device memory by a controller and a host processor of an electronic device according to an embodiment of the present disclosure.

FIG. 5 illustrates a method of accessing a device memory by a host program and a device program according to an embodiment of the present disclosure.

FIG. 6 illustrates a process of accessing a host memory region of a device memory according to an embodiment of the present disclosure.

FIG. 7 illustrates a process of accessing a host memory region by a controller according to an embodiment of the present disclosure.

FIG. 8 illustrates a process of accessing a device-dedicated memory region according to an embodiment of the present disclosure.

Embodiments of the present disclosure will be described with reference to the accompanying drawings to be described below, wherein like reference numerals indicate like elements, but are not limited thereto.

### DETAILED DESCRIPTION

Hereinafter, specific details for implementation of the present disclosure will be described in detail with reference to the accompanying drawings. However, in the following description, when there is a concern of unnecessarily obscuring a gist of the present disclosure, a detailed description of a well-known function or configuration will be omitted.

In the accompanying drawings, identical or corresponding components are given identical reference numerals. In addition, in the description of the following embodiments, overlapping descriptions of identical or corresponding components may be omitted. However, even if a description of a component is omitted, it is not intended that the component is not included in an embodiment.

Advantages and features of the disclosed embodiments, and a method of achieving the advantages and the features, will become apparent with reference to embodiments described below in conjunction with the accompanying drawings. However, the present disclosure is not limited to the embodiments disclosed below, and may be implemented in various different forms, and the present embodiments are merely provided to complete the present disclosure, and to completely inform a person having ordinary skill in the art of a scope of the invention.

Terms used in this specification will be briefly described, and the disclosed embodiments will be specifically described. The terms used in this specification have been selected from general terms that are currently widely used as possible while considering functions in the present disclosure, but the general terms may vary depending on an intention of a technician engaged in a related field, a precedent, an emergence of a new technology, and the like. In addition, in a specific case, there are also terms arbitrarily selected by an applicant, and in this case, a meaning of the terms arbitrarily selected by the applicant will be described in detail in a corresponding description part of the invention. Therefore, the terms used in the present disclosure should be defined based on a meaning of the terms and overall contents of the present disclosure, rather than simply names of the terms.

A singular expression in this specification includes a plural expression unless a context clearly specifies that the singular expression is singular. In addition, a plural expression includes a singular expression unless a context clearly specifies that the plural expression is plural. When a part in the entire specification includes a component, the part does not exclude another component but may further include another component unless otherwise specifically stated.

In addition, a term 'module' or 'unit' used in the specification means a software or hardware component, and the 'module' or the 'unit' performs certain roles. However, the 'module' or the 'unit' does not mean being limited to software or hardware. The 'module' or the 'unit' may be configured to be on an addressable storage medium, and may be configured to reproduce one or more processors. Therefore, as an example, the 'module' or the 'unit' may include at least one of components such as software components, object-oriented software components, class components, and task components, processes, functions, attributes, procedures, subroutines, segments of program codes, drivers, firmware, microcodes, circuits, data, databases, data structures, tables, arrays, or variables. Functions provided in the components and the 'modules' or the 'units' may be combined into a smaller number of components and 'modules' or 'units', or may be further separated into additional components and 'modules' or 'units'.

According to an embodiment of the present disclosure, the 'module' or the 'unit' may be implemented with a processor and a memory. The 'processor' should be construed broadly to include a general purpose processor, a central processing unit (CPU), a microprocessor, a digital signal processor (DSP), a controller, a microcontroller, a state machine, and the like. In some environments, the 'processor' may refer to an application specific integrated circuit (ASIC), a programmable logic device (PLD), a field programmable gate array (FPGA), and the like. The 'processor' may refer to a combination of processing devices such as, for example, a combination of a DSP and a microprocessor, a combination of a plurality of microprocessors, a combination of one or more microprocessors combined with a DSP core, or a combination of any other such configurations. In addition, the 'memory' should be construed broadly to include any electronic component capable of storing electronic information. The 'memory' may refer to various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), a flash memory, a magnetic or optical data storage device, registers, and the like. If the processor can read information from and/or write information to the memory, the memory is referred to as being in electronic communication with the processor. The memory integrated into the processor is in electronic communication with the processor.

In the present disclosure, a 'system' may include at least one device of a server device and a cloud device, but is not limited thereto. For example, the system may be configured with one or more server devices. As another example, the system may be configured with one or more cloud devices. As another example, the system may operate by configuring the server device and the cloud device together.

In the present disclosure, a 'display' may refer to any display device associated with a computing device, for example, may refer to any display device capable of displaying any information/data controlled by the computing device or provided from the computing device.

In the present disclosure, 'each of a plurality of A' or 'each of the plurality of A' may refer to each of all components included in the plurality of A, or may refer to each of some components included in the plurality of A.

Hereinafter, various embodiments of the present disclosure will be described in detail according to the accompanying drawings. A size or a position of a display screen, an image, a button, etc. illustrated and described in the drawings is an example, and is not limited thereto. For example, some buttons may be added or omitted, or may be configured with a different size and position from those illustrated. In addition, a flowchart illustrated in the drawings and a description thereof are merely an example, and may be implemented differently in some embodiments. For example, one or more steps may be omitted, an order of each step may be changed, one or more steps may be performed to be overlapped, or one or more steps may be repeatedly performed multiple times.

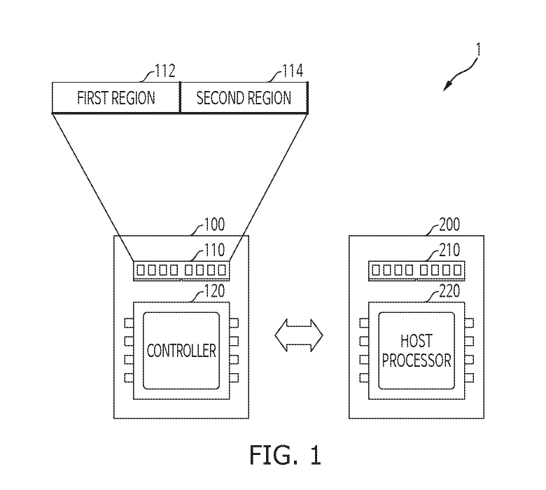

FIG. 1 illustrates a computing system 1 according to an embodiment of the present disclosure.

Referring to FIG. 1, the computing system 1 may include a combination of hardware and software capable of processing data and performing an operation. The computing system 1 may include a storage server or another type of server that may be used in a data center, and may include an electronic device 100 and a host device 200.

The host device 200 may include a host memory 210 and a host processor 220. The host memory 210 is a memory primarily used by the host processor 220, and may include at least one of a random access memory (RAM), a cache memory, a non-volatile memory, or a unified memory, but is not limited thereto.

The host processor 220 may include a set of one or more processors. The host processor 220 may drive software (e.g., an instruction, a program, etc.) to control at least one component of a device or a terminal (e.g., the electronic device 100) connected to the host processor 220. In addition, the host processor 220 may perform an operation such as various calculations, processings, data generations, or processings. In addition, the host processor 220 may load data, etc. from various memory devices or storage devices, or store the data, etc. in the memory devices or the storage devices.

The electronic device 100 may be a configuration performing a specific task according to an instruction of the host processor 220. That is, the electronic device 100 may be a device for performing an offloading (distributed processing) including at least one of an artificial intelligence inference, an image processing, or a data analysis. For example, the electronic device 100 may include a graphics processing unit (GPU), a tensor processing unit (TPU), a neural processing unit (NPU), a field-programmable gate array (FPGA), an application-specific integrated circuit (ASIC), and the like, but the present disclosure is not limited thereto.

The electronic device 100 may include a device memory 110 and a controller 120. The device memory 110 may be a compute express link (CXL) memory, and may be divided into a plurality of regions 112 and 114. A first region 112 is a device private memory (DPM) region of the electronic device 100, and a second region 114 is disposed in the device memory 110 of the electronic device 100, but is a host attached device memory (HDM) region associated with the host memory 210, and may be included in a control range of the host processor 220.

The first region 112 may be a device private memory (DPM) of an electronic device supporting a CXL.io protocol. The CXL.io may include an input/output interface compatible with an existing PCIe. The first region 112 may include data associated with at least one of a code, a stack, or a heap during a runtime of a specific program. In addition, the first region 112 may store at least one of predefined data, data for which an access restriction authority is set by the controller 120, or data for which a user change is restricted, but the present disclosure is not limited thereto.

The second region 114 may support a CXL.mem protocol providing an extended memory by utilizing a shared memory. The second region 114 is disposed in the electronic device 100 but is an HDM region, and may include data satisfying a cache coherence with the host memory 210 in the host device 200. The host processor 220 may manage the host memory 210 included in the host device 200 and the second region 114. For example, the host processor 220 may manage the second region 114 based on a virtual addressing scheme, which is an addressing scheme of the host device 200.

The second region 114 may address or store at least one of shared data or data associated with a frequent input or output.

The controller 120 may have one or more memory channels, and may communicate with an individual component or a memory device through the memory channels. A corresponding memory channel may be a volatile memory channel, a non-volatile memory channel, or a memory channel based on an address region connected to a solid state drive (SSD), but the present disclosure is not limited thereto. The controller 120 may access the first region 112 according to a memory address allocation scheme of the electronic device 100. For example, the controller 120 may access the first region 112 based on a physical addressing scheme, but is not limited thereto.

The controller 120 may access the second region 114 according to a memory address allocation scheme of the host device 200. For example, the controller 120 may access the second region 114 based on a virtual addressing (or physical Addressing) scheme, but is not limited thereto.

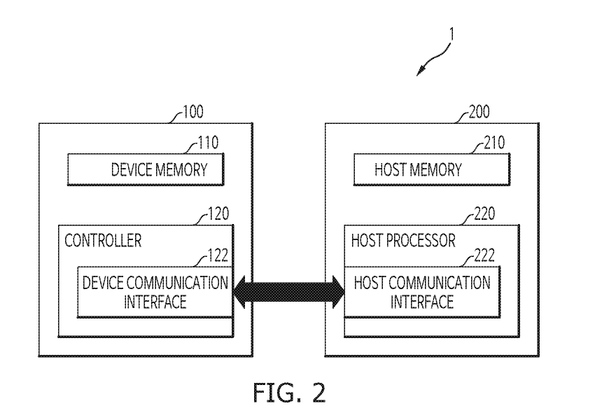

FIG. 2 illustrates a communication scheme of the computing system 1 according to an embodiment of the present disclosure.

Referring to FIG. 2, the electronic device 100 may include the device memory 110 and the controller 120, and the host device 200 may include the host memory 210 and the host processor 220.

The controller 120 may communicate with the host processor 220 through a device communication interface 122. The device communication interface 122 may be an interface based on a serial communication, and may include one or more communication ports. The device communication interface 122 may be an interface using a peripheral component interconnect express (PCIe) or compute express link (CXL) protocol, but the present disclosure is not limited thereto.

The host processor 220 may communicate with the controller 120 through a host communication interface 222. The host communication interface 222 may be an interface based on a serial communication, but the present disclosure is not limited thereto.

The host processor 220 may transmit an instruction for offloading to the controller 120. The host processor 220 may copy and use data based on direct memory access (DMA) to access a device-dedicated memory region of the device memory 110. In addition, the host processor 220 may access a host memory region of the device memory 110 to load or store data based on a virtual addressing scheme.

The controller 120 may access the device-dedicated memory region and the host memory region of the device memory 110 according to an instruction of the host processor 220, to load or store data.

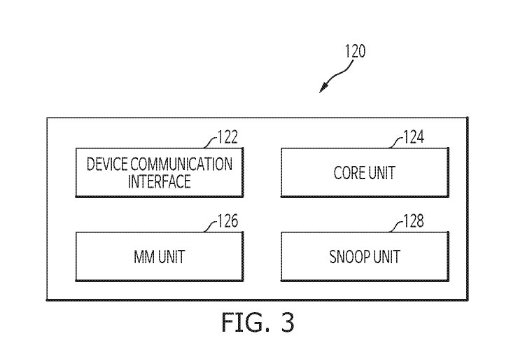

FIG. 3 illustrates a configuration of the controller 120 according to an embodiment of the present disclosure.

Referring to FIG. 3, the controller 120 may include at least one of the device communication interface 122, a core unit 124, an MM unit 126, or a snoop unit 128.

The device communication interface 122 is a module for communicating with a host processor, may include a serial communication interface, and may include one or more communication ports.

The core unit 124 may include a processor core that processes a specific task in a controller. The core unit 124 may be one or more, and may perform at least one of an operation of a matrix or a vector, a hashing operation, an encoding or decoding, or a training or inference based on deep learning, but is not limited thereto.

The core unit 124 may determine whether to access the first region 112 or the second region 114 of the device memory 110 based on information transmitted from the host processor.

The MM (Memory Management) unit 126 may translate a virtual address space allocated to the host memory or the host memory region into a physical address space. The MM unit 126 may translate an address space mapped to a host virtual address space by a host process into a physical addressing scheme, which is an addressing scheme of the electronic device 100, to map the address space to a host physical address space.

The snoop unit 128 may be a unit for satisfying a cache coherence of a physical address space of a host and a host memory region (second region) in the device memory 110. The snoop unit 128 may store host caching information indicating a state in which data stored in the device memory 110 is cached in a host cache memory. The host caching information may include a time point when data stored in a specific address of the device memory 110 is registered in the host cache memory and a time point when the data is removed from the host cache memory.

The core unit 124 may access the host memory region of the device memory 110 through the MM unit 126 and the snoop unit 128 to perform a load or store operation.

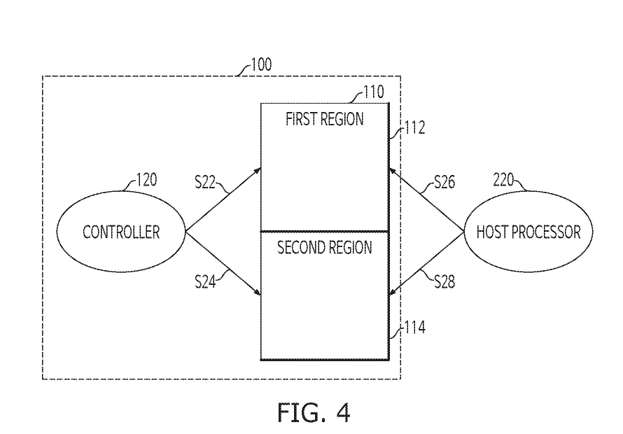

FIG. 4 illustrates a method of accessing the device memory 110 by the controller 120 and the host processor 220 of an electronic device according to an embodiment of the present disclosure.

Referring to FIG. 4, the device memory 110 of the electronic device 100 may be divided into the first region 112 and the second region 114. The first region 112 is a region within a control range of the controller 120, and may be a device private memory (DPM) region. The second region 114 is included in the electronic device 100 but may be a region associated with the host processor 220, and may be a host attached device memory (HDM) region. In an embodiment, the controller 120 may divide the device memory 110 into the first region 112 and the second region 114 before using the device memory 110, or may divide the device memory 110 during manufacturing of the electronic device 100, but the present disclosure is not limited thereto.

The first region 112 may include data associated with at least one of a code, a stack, or a heap during a runtime of a specific program. In addition, the first region 112 may store at least one of predefined data, data for which an access restriction authority is set by the controller 120, or data for which a user change is restricted, but the present disclosure is not limited thereto.

The controller 120 may freely access S22 the first region 112, and may access the first region 112 based on an addressing scheme of the electronic device 100. For example, the controller 120 may access the first region 112 based on a physical addressing scheme.

The host processor 220 may access S26 the first region 112 through a memory copy scheme to copy data of the first region 112 or store data in the first region 112.

The second region 114 is a region associated with a host memory and the host processor 220, and may be a host attached device memory (HDM) controlled by the host processor 220 without being disposed in a host device. The host processor 220 may freely access S28 the second region 114 through a load or store instruction.

The controller 120 may translate a virtual address based on a physical address to access S24 the second region 114 on which a coherence process with the host memory has been performed. The controller 120 may need to obtain a permission of the host processor 220 to access S24 the second region 114, but the present disclosure is not limited thereto.

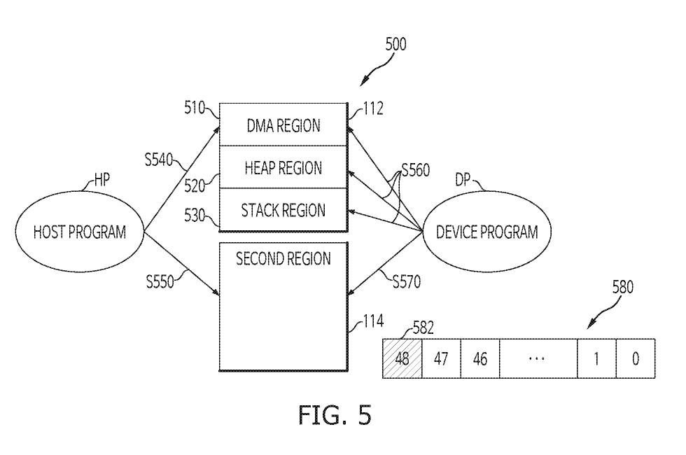

FIG. 5 illustrates a method 500 of accessing a device memory by a host program HP and a device program DP according to an embodiment of the present disclosure.

Referring to FIG. 5, the host program HP may be an operation system (OS) program executed by a host processor, and the device program DP is a specific program executed by the electronic device 100, and may be a program executed in the core unit 124 of the electronic device 100.

First, the host program HP may set a runtime memory region corresponding to the device program DP through a runtime configuration process. The host program HP may set the first region 112, and the first region 112 may include at least one of a DMA region 510, a code region, a heap region 520, or a stack region 530.

The DMA region 510 is a region capable of a data transmission without an intervention of the host processor, and may rapidly transmit data by efficiently utilizing a bus bandwidth. The DMA region 510 may be used for a network packet processing, a disk input/output, or a graphic operation. The DMA region 510 may be a region that the host program HP and the device program DP may access S540 and S560.

The heap region 520 may have a heap base set at an initialization time point of the device program DP. The heap base may be set to '(0x1<<48) | HEAP_OFFSET', but the present disclosure is not limited thereto. The heap region 520 may be a region that the device program DP may access S560.

The stack region 530 may have a stack base set at the initialization time point of the device program DP. The stack base may be set to '(0x1<<48) | STACK_OFFSET', but the present disclosure is not limited thereto. The stack region 530 may be a region that the device program DP may access S560.

After the host program HP sets a runtime memory (the first region 112), a device runtime may allocate an address associated with at least one of a code, a stack, or a heap to the first region 112. The device runtime may be configured to allocate a region associated with at least one of the code, the stack, or the heap during a runtime of a specific program. That is, a corresponding region may be allocated by a host runtime and the device runtime performed in a host processor and a controller.

Here, the device runtime is a program providing an environment for operation offloading, and may be a program transmitting at least one of code, data, or a result of an execution instruction to the host device 200. For example, the device runtime may store the result of the execution instruction of the host device 200 or a completion signal in a pre-arranged position of the first region 112 based on DMA or a designated position of the host device 200 in order to transmit the result of the execution instruction or the completion signal to the host device 200. In addition, the host runtime is also disposed in the host device 200, so that the code, the data, or the execution instruction may be transmitted to the electronic device 100.

In this case, the host program may set a runtime memory of the device program DP to be the first region 112 by setting a value of a specific address bit (e.g., a 48th bit 582) of a specific address 580 to '1', but the present disclosure is not limited thereto.

The host processor may perform a memory allocation of the second region 114. When the host processor allocates a memory to the second region 114, the host processor may allocate the memory based on a virtual addressing. The host processor may transmit an address allocated to the second region to the controller 120 through an argument of a command descriptor. An offloading runtime of an electronic device may set a value of the specific address bit 582 received from the host processor 220 to a first value (e.g., '0') (or, if the specific address bit is defaulted to the first value, a setting may be omitted). When the value of the specific address bit 582 is the first value, the controller 120 may determine whether to access the second region 114 based on a virtual addressing scheme.

The specific address bit may include one or more bits. For example, when the specific address bit includes a single bit, a first value (e.g., '0') may indicate access to the second region based on the virtual addressing scheme, and a second value (e.g., '1') may indicate access to the first region based on the physical addressing scheme. For example, when the specific address bit includes two or more bits, different bit values may indicate access to the first region, access to the second region, or access to both the first region and the second region based on the respective addressing schemes.

In addition, the controller 120 may determine whether to access the first region 112 based on a physical addressing scheme, based on a value of the specific address bit 582 of the specific address 580 received from the host processor 220. For example, when the value of the specific address bit 582 is a second value (e.g., '1'), the controller 120 may access the first region 112 based on the physical addressing scheme.

An address covering the first region 112 and the second region 114 of the device memory 110 is a separate address space called a "device physical address", and the controller 120 may access the first region 112 based on a device physical addressing scheme, and may access the second region 114 by translating a host address into the device physical address based on a host virtual addressing scheme.

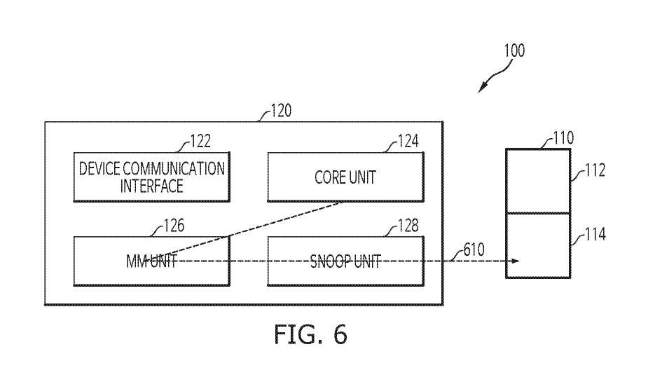

FIG. 6 illustrates a process of accessing the host memory region 114 of the device memory 110 according to an embodiment of the present disclosure.

Referring to FIG. 6, the device memory 110 may include the first region 112, which is a device-dedicated memory region, and the second region 114, which is a host memory region. The controller 120 may include the device communication interface 122, the core unit 124, the MM unit 126, and the snoop unit 128.

When a preset value of a specific address bit is a first value (e.g., '0'), the core unit 124 may attempt 610 an access to the second region 114.

The MM unit 126 may translate a virtual address space allocated to a host memory into a physical address space. That is, the MM unit 126 may translate a virtual address space into a physical address space in order to access the second region 114 allocated with a memory according to an address system of the host memory.

The snoop unit 128 may satisfy a cache coherence of the physical address space and the second region 114. Accordingly, when the value of the specific address bit received from the host processor is the first value (e.g., '0'), the controller 120 may access a specific address of the second region 114.

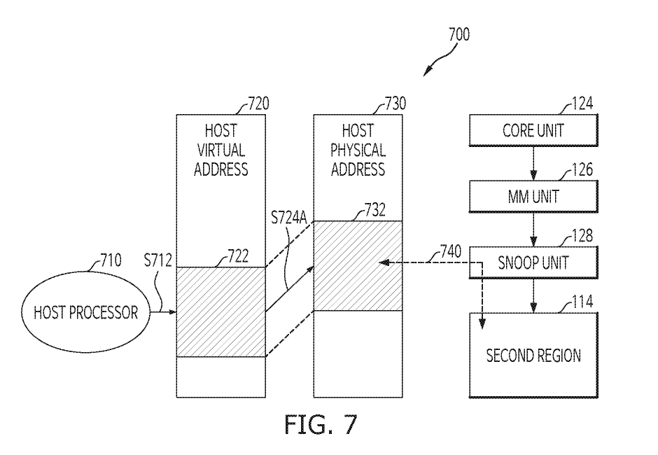

FIG. 7 illustrates a process 700 of accessing a host memory region by a controller according to an embodiment of the present disclosure.

Referring to FIG. 7, the core unit 124 may determine whether to access the second region 114, which is a host memory region, based on a value (e.g., '0') of a specific address bit set by an offloading runtime.

When the MM unit 126 receives an instruction to access the second region 114 by the core unit 124, the MM unit 126 may translate a specific space 722 of a host virtual address 720 set S712 by a host processor 710 into an address space of the second region 114 of the device memory 110.

The host processor 710 may translate S724A a host virtual address 722 into a host physical address 732 by a host OS and an MM unit of a host, and then transmit the host physical address 732 to the electronic device 100. The electronic device 100 may translate the host physical address 732 into an address of the second region 114 according to an address mapping method 740 defined by a CXL standard. That is, if the core unit 124 goes through the MM unit 126, a host virtual address may be translated into the address of the second region 114. Accordingly, the controller 120 may directly access the second region 114.

The snoop unit 128 may satisfy a coherence of the second region 114 and a specific space 732 of a host physical address 730, and the controller 120 may access the second region 114 to read or store specific data.

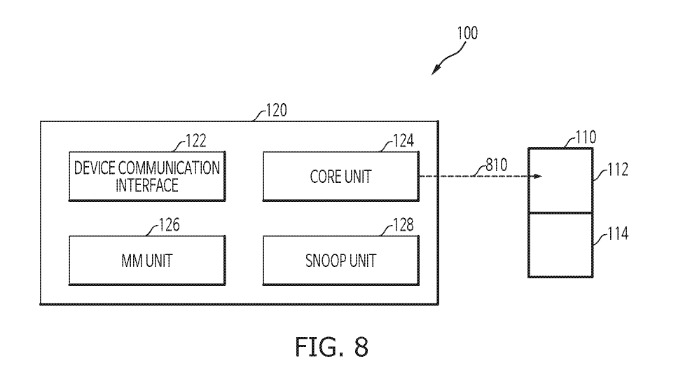

FIG. 8 illustrates a process of accessing a device-dedicated memory region according to an embodiment of the present disclosure.

When a preset value of a specific address bit is set to a second value (e.g., '1'), the core unit 124 may directly access the first region 112. The MM unit 126 and the snoop unit 128 may skip an operation when a value of a specific address bit is set to a second value. Accordingly, the core unit 124 may directly access the first region 112 based on a physical address.

Although the present disclosure has been described with respect to some embodiments in the present specification, various modifications and changes may be made without departing from a scope of the present disclosure that a person having ordinary skill in the art to which an invention of the present disclosure belongs may understand. In addition, such modifications and changes should be considered to fall within the scope of the claims appended to this specification.

What is claimed is:

1. An electronic device comprising:
a memory comprising a first region and a second region, the second region being associated with a host memory of a host device; and
a controller circuit configured to be connected to the memory,
wherein the controller circuit is configured to:
based on a value of a specific address bit received from a host processor of the host device, determine:
whether to access the first region based on a physical addressing scheme, or
whether to access the second region based on a virtual addressing scheme, and
access, based on the determination, at least one of the first region or the second region.

2. The electronic device of claim 1, wherein the first region is a device-dedicated memory region of the electronic device, and wherein the first region comprises data associated with at least one of a code, a stack, or a heap during a runtime of a specific program.

3. The electronic device of claim 1, wherein the second region is a host memory region, and wherein the second region comprises data satisfying cache coherence with the host memory.

4. The electronic device of claim 1, wherein the controller circuit comprises a memory management (MM) circuit and a snoop circuit, wherein the MM circuit is configured to translate a virtual address space allocated to the host memory into a physical address space, wherein the snoop circuit satisfies a cache coherence between the physical address space and the second region, and wherein the controller circuit is configured to access the second region when the value of the specific address bit received from the host processor is a first value.

5. The electronic device of claim 4, wherein the controller circuit is configured to access the first region when the value of the specific address bit received from the host processor is a second value.

6. The electronic device of claim 1, wherein the first region is configured to be accessed by the host processor through a memory copy operation, and wherein the second region is configured to be accessed by the host processor through a load or store instruction.

7. A computing system comprising:
a host device comprising a host processor and a host memory; and
an electronic device,
wherein the electronic device comprises:
a memory comprising a first region and a second region, the second region being associated with the host memory; and
a controller circuit configured to be connected to the memory and the host processor, and wherein the controller circuit is configured to:
based on a value of a specific address bit received from the host processor, determine:
whether to access the first region based on a physical addressing scheme, or
whether to access the second region based on a virtual addressing scheme, and
access, based on the determination, at least one of the first region or the second region.

8. The computing system of claim 7, wherein the first region is a device-dedicated memory region of the electronic device, and wherein the first region comprises data associated with at least one of a code, a stack, or a heap during a runtime of a specific program.

9. The computing system of claim 7, wherein the second region is a host memory region, and wherein the second region comprises data satisfying cache coherence with the host memory.

10. The computing system of claim 7, wherein the controller circuit comprises a memory management (MM) circuit and a snoop circuit, wherein the MM circuit is configured to translate a virtual address space allocated to the host memory into a physical address space, wherein the snoop circuit satisfies a cache coherence between the physical address space and the second region, and wherein the controller circuit is configured to access the second region when the value of the specific address bit received from the host processor is a first value.

11. The computing system of claim 10, wherein the controller circuit is configured to access the first region when the value of the specific address bit received from the host processor is a second value.

12. The computing system of claim 7, wherein the first region is configured to be accessed by the host processor through a memory copy operation, and wherein the second region is configured to be accessed by the host processor through a load or store instruction.

13. The computing system of claim 8, wherein a host runtime executed in the host processor and a runtime of the electronic device executed in the controller circuit are configured to allocate a region associated with at least one of the code, the stack, or the heap during the runtime of the specific program.

14. An electronic device comprising:
a memory comprising a first region and a second region, wherein the second region is associated with a host memory of a host device; and
circuitry coupled to the memory, the circuitry configured to:
determine, based on a value of a specific address bit received from a host processor of the host device,
whether to access the first region based on a physical addressing scheme, or
whether to access the second region based on a virtual addressing scheme,
access the second region based on the virtual addressing scheme when the value of the specific address bit is a first value, and
access the first region based on the physical addressing scheme when the value of the specific address bit is a second value.

15. The electronic device of claim 14, wherein the circuitry comprises a device communication interface configured to communicate with the host processor via a compute express link (CXL) protocol.

16. The electronic device of claim 14, wherein the circuitry comprises a core circuit configured to perform at least one of an operation of a matrix or a vector, a hashing operation, an encoding or decoding, or a training or inference based on deep learning.

17. The electronic device of claim 14, wherein the first region stores at least one of predefined data, data for which an access restriction authority is set by the circuitry, or data for which a user change is restricted.

18. The electronic device of claim 14, wherein the second region is configured to address or store shared data between the electronic device and the host processor.

19. The electronic device of claim 14, wherein the circuitry is configured to divide the memory into the first region and the second region before using the memory.

20. The electronic device of claim 14, wherein the first region is a device private memory region, and the second region is a host-attached device memory region that maintains cache coherence with the host memory.
